(19) United States
(12) Patent Application Publication
(10) Pub. No.: US 2013/0016648 A1
(43) Pub. Date: Jan. 17, 2013

(54) Connectivity Setup For Dynamic Wireless Mesh Networks

(71) Applicants: Timo K. Koskela, Oulu (FI); Sami-Jukka Hakola, Kempele (FI); Samuli Turtinen, Ii (FI); Anna Pantelidou, Oulu (FI); Juho Pirskanen, Tampere (FI)

(72) Inventors: Timo K. Koskela, Oulu (FI); Sami-Jukka Hakola, Kempele (FI); Samuli Turtinen, Ii (FI); Anna Pantelidou, Oulu (FI); Juho Pirskanen, Tampere (FI)

(73) Assignee: Renesas Mobile Corporation

(21) Appl. No.: 13/183,542

(22) Filed: Jul. 15, 2011

(51) Int. Cl. H04W 48/00

(52) U.S. Cl. 370/315

(57) ABSTRACT

A wireless backhaul link is established by sending from a mobile first access node to a second access node a priority request message requesting high priority for a link between them. The established wireless backhaul link is utilized as part of a wireless multihop connection between the second access node and at least one user device attached to the mobile first access node. In various embodiments the high priority is requested by indicating a priority class (e.g., highest priority, at least higher than any current priority, and at least as high as a highest current priority) and may also indicate how many user devices are attached and/or an amount of data waiting to be sent. A first timer may be initiated upon inactivity on the wireless backhaul link and continuous inactivity through expiry of that automatically results in a reduction of the priority class for the wireless backhaul link.

### TECHNICAL FIELD

The exemplary and non-limiting embodiments of this invention relate generally to wireless communication systems, methods, devices and computer programs and, more specifically, relate to setting up a wireless backhaul link from a mobile node/access point serving its own users/stations.

### BACKGROUND

The following abbreviations that may be found in the specification and/or the drawing figures are defined as follows:

2G 2^{nd} Generation

3G 3^{rd} Generation

3GPP third generation partnership project

AP access point

BSS basic service set

DCF distributed coordination function

eNB evolved NodeB

ESS extended service set

FILS fast initial link setup

IEEE Institute of Electrical and Electronics Engineers

LAN local area network

LTE long term evolution (evolved UTRAN)

MAC medium access control

PCF point coordination function

RAT radio access technology

STA station

SSID service set identifier

QoS quality-of-service

UTRAN universal terrestrial radio access network

WLAN wireless LAN

As wireless radio access becomes more ubiquitous, additional use cases arise for which more conventional access schemes are not particularly viable. The concept of a wireless backhaul link is not itself new but is applied for more and varied use cases which can be more efficiently met with new procedures.

Wireless backhaul is needed where the access node providing connectivity between the mobile user devices under its control and a broader communication system such as a cellular network or the Internet does not itself have a wired or optical or fixed wireless connection to that network/Internet. A fixed AP may still be fixed despite having a wireless backhaul link if, for example, it and its peer across that wireless backhaul connection are not mobile so that the backhaul radio resources generally do not change greatly. In the case of a mobile AP having a wireless backhaul link radio resources must be dynamically allocated for both the conventional wireless links between the access node and its attached user devices, and also for the backhaul link which carries both the access node's uplink traffic to the network/Internet and traffic from the network/Internet to the access node for further transmission downlink.

FIG. 1 illustrates an exemplary scenario needing dynamic wireless backhaul. There is a series of fixed APs (1, 2, . . . N) which operate conventionally and with fixed (non-wireless) backhaul links 101 such as a digital subscriber line. Each of them may have their own set of attached user devices, shown by example as a STA attached to fixed AP 1. The fixed APs may for example be implemented as conventional (macro) base stations/node Bs/eNBs or as femto cells of a LTE network or any mix thereof.

There is additionally at FIG. 1 a mobile AP 1 which has its own set of attached STAs. By example, assume the mobile AP 1 is a user device on a train acting as an AP STA for the two illustrated non-AP STAs also on the train. As the train and the mobile AP 1 move in the direction of the arrow the wireless backhaul link 102 used by the mobile AP 1 moves from fixed AP 1 to fixed AP 2 and finally to fixed AP #N. Being on a train moving along a fixed track, all of these APs fixed and mobile are part of an extended service set ESS 103. From the STAs attached to the mobile AP 1 there is then a multihop wireless link to the network backbone, a first hop to the mobile AP 1 and a second along the wireless backbone running between mobile AP 1 and whichever fixed AP it is connected at a given time. More than two wireless hops is also a viable scenario.

While the terms AP and STA used in FIG. 1 are conventional for WLAN, such a scenario is not specific to any given RAT. In fact, if one assumes the various APs in FIG. 1 are each equipped with multiple radios then they can provide connectivity to their locally attached STAs using a local radio (such as IEEE 802.11 wireless LAN, Bluetooth or Zigbee) and a conventional cellular radio (e.g., 2G, UTRAN, LTE) for any wireless backhaul connection they support. Or the wireless backhaul can be the same family as the local connection, such as IEEE 802.11ac for the local high throughput connection and IEEE 802.11ah or 802.11af for the longer range wireless backhaul, or an LTE-A femto node or UE as the mobile AP and a LTE (or LTE-A) macro eNB as the fixed AP. The mobile AP 1 may serve a more limited access function, storing user data locally and providing downlink streaming services to them as well as facilitating communications among its attached STAs.

Since the mobile AP in FIG. 1 moves in and out of coverage of different fixed APs the connection setup and the initiation of the relatively short data transmission session between mobile AP and fixed AP should be efficient.

Under discussion in the IEEE standardization for 802.11 is an enhancement to the FILS, which is in IEEE 802.11ai. One scenario for enhanced FILS, and which FIG. 1 illustrates, is the so-called train station lobby scenario at section 3.3.3 of document IEEE 802.11-11/0238r11a (March 2011). A train with a mobile hot spot (mobile AP 1) arrives to the station while the mobile AP has an AP to STA interface 104 for communicating with the STAs in the train and it also has a non-AP interface (the wireless backhaul link 102) for connecting to the fixed AP at the station. Of particular relevance is that the mobile AP's communication over the non-AP interface 102 with the fixed AP is not distinguishable from a normal STA, which might cause severe problems in the mobile AP providing connectivity for its associated STAs.

### SUMMARY

The foregoing and other problems are overcome, and other advantages are realized, by the use of the exemplary embodiments of this invention.

In a first exemplary embodiment of the invention there is a method comprising: establishing a wireless backhaul link by sending from a mobile first access node to a second access node a priority request message requesting high priority for a link between the mobile first access node and the second access node; and utilizing the established wireless backhaul link as part of a wireless multihop connection between the second access node and at least one user device attached to the mobile first access node.

In a second exemplary embodiment of the invention there is an apparatus comprising a processing system comprising at least one processor and a memory storing a set of computer instructions. In this embodiment the processing system is arranged to: establish a wireless backhaul link by sending from a mobile first access node to a second access node a priority request message requesting high priority for a link between the mobile first access node and the second access node; and utilize the established wireless backhaul link as part of a wireless multihop connection between the second access node and at least one user device attached to the mobile first access node.

In a third exemplary embodiment of the invention there is a computer readable memory storing a set of instructions which, when executed by an apparatus, cause the apparatus to: establish a wireless backhaul link by sending from a mobile first access node to a second access node a priority request message requesting high priority for a link between the mobile first access node and the second access node; and utilize the established wireless backhaul link as part of a wireless multihop connection between the second access node and at least one user device attached to the mobile first access node.

### BRIEF DESCRIPTION OF THE DRAWINGS

FIG. 1 is a schematic diagram showing one scenario in which a mobile AP with attached STAs has a wireless backhaul link with various fixed APs as it travels, and is an environment in which embodiments of the invention may be advantageously practiced.

FIG. 2 is a signaling diagram illustrating a mobile first access node with an attached station establishing a wireless backhaul link with a second access node according to an exemplary embodiment of the invention.

FIG. 3 is a schematic diagram of a WLAN management frame format which may be adapted to signal the priority request message of FIG. 2 according to an exemplary embodiment of these teachings.

FIG. 4 is a logic flow diagram illustrating the operation of a method, and a result of execution of computer program instructions embodied on a computer readable memory, for establishing and releasing the wireless backhaul link of FIG. 2 according to an exemplary embodiment of these teachings.

FIG. 5 is a simplified block diagram of the nodes shown at FIG. 2 which are exemplary electronic devices suitable for use in practicing the exemplary embodiments of this invention.

### DETAILED DESCRIPTION

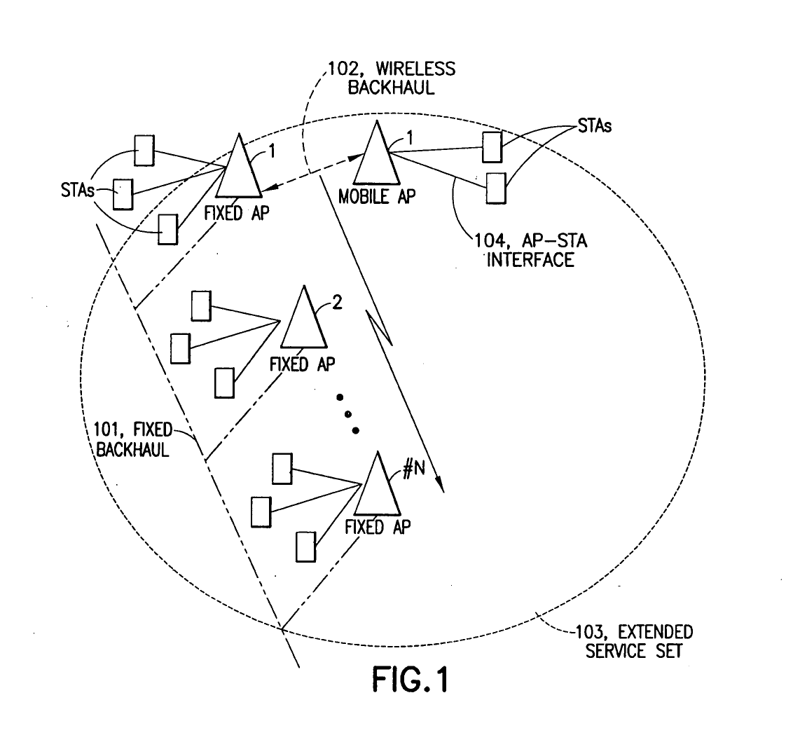

In the environment of FIG. 1 consider the mobile AP as a mobile first access node, and the AP with which it is establishing a wireless backhaul link as a second access node. In conventional practice and particularly if the wireless link between the first and second nodes is a WLAN link the second node has no way to know that the link being established is for wireless backhaul, for the mobile first node is no different than a normal station. According to exemplary embodiments of these teachings the mobile first access node indicates to the second node when establishing that wireless backhaul link a request for high priority. Particularly if the mobile first access node utilizes an inter-AP communication mechanism to communicate with the (fixed) second access node, the mobile first access node can more explicitly indicate its need for extra capacity as will be detailed below. Typically for the station lobby scenario noted in the background section above such extra capacity will only be needed for the relatively short period of time since at least some of those stations attached to the mobile first access node will disembark at that rail station and no longer remain attached to the same mobile first access node.

A mobile first access node (AP) has one or more stations (STA) associated to it as in FIG. 1 and it is moving into the coverage area of a second access node (preferably fixed but this also may be mobile) such as AP #N. The second access node also provides local connectivity to those STAs associated to it. Once the wireless backhaul is established, the mobile first access node can additionally act as a relaying node for those stations associated to it.

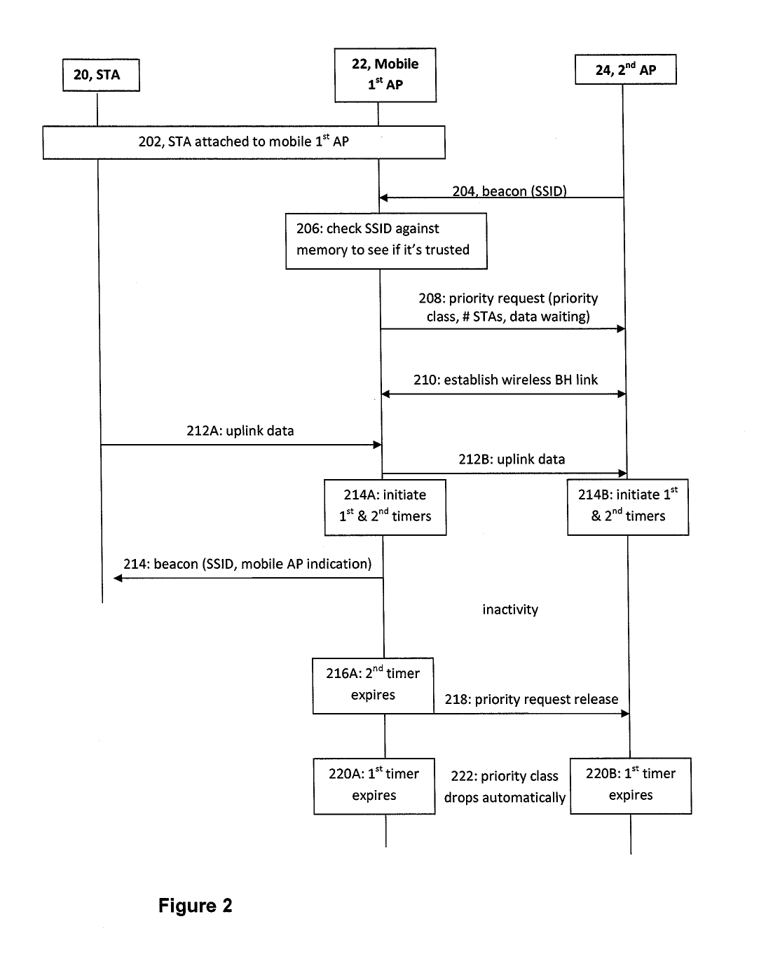

FIG. 2 is an overview of an exemplary but non-limiting signaling regimen according to these teachings. Begin with the initial condition 202 at which a STA 20 is associated to or attached to the mobile first node or AP 22. As the mobile first AP 22 is in transit it reads the beacon 204 which the second access node/AP 24 broadcasts, and this beacon includes the SSID of the second AP 24. The mobile first AP 22 checks at block 206 this received SSID against a set of SSIDs stored locally in the memory of the mobile first AP 22. These stored or pre-set SSIDs are considered to be trusted. The purpose of this check is to prevent the mobile first AP 22 from connecting to some other AP which is not capable of properly supporting a wireless backhaul link, such as for example if that other AP were not security enabled, or is not part of the same network as the mobile first AP 22. Establishment of the wireless backhaul link via message 208 below is contingent on passing this ‘trusted’ check. In other embodiments this check is optional.

Then the mobile first access point 22 transmits a priority request message 208 to the second AP 24 in order to establish wireless backhaul. In an embodiment this priority request message 208 requests a high priority operational mode for the mobile AP. This may in some cases depend on the QoS support of the second AP 24. In one embodiment the priority request message 208 indicates to the second access point 24 a priority class for the backhaul link being setup. In this example the priority class indicated in the request 208 may be for example: highest supported priority class, at least higher than any current priority class, or at least equal to the highest current priority class. These priority classes are in reference to the links which the second AP 24 has established already for the STAs associated to that second AP 24. The priority request 208 is evaluated by the second AP 24 which further grants or denies the priority request.

In specific but non-limiting embodiments, instead of or in addition to the priority class, the mobile first access node 22 may include in its priority request message 208 an indication of how many STAs are associated to the mobile first AP 22, or an amount of data (either data volume or buffer occupancy) that is waiting to be sent on the requested wireless backhaul link. In one specific embodiment the priority granted to the new wireless backhaul link will be automatically dropped to a lower priority as detailed below with respect to the timers 216A, 216B.

Now assume the wireless backhaul link is setup via completion signaling at 210. In an embodiment the mobile first AP 22 can be configured at the MAC layer to indicate explicitly that it is a mobile AP. This ‘mobility indication’ can be transmitted in the information element of a beacon message 214 (which also carries the SSID of the transmitting AP 22). This embodiment helps prevent random STAs from connecting to the mobile first AP 22 which will not be available for a very long period, for example if the random STA was near the railroad tracks while the train on which the mobile first AP 22 was passing nearby, or the mobile AP 22 is passing through a city center at which are several STAs moving all in different directions.

With the wireless backhaul link established, the associated STA 20 sends data uplink at 212A which the mobile first AP 22 sends on the wireless backhaul link to the second AP 24 at 212B. This activity on the wireless backhaul link causes a timer to be initiated 214A at the mobile first AP 22 and also 214B at the second AP 24. FIG. 2 shows distinct first and second timers but they may be implemented as only one. If the first timer expires 220A/220B while there is continuous inactivity on the wireless backhaul link the priority class requested at 208 and granted at 210 is automatically dropped to a lower level. This may occur without signaling, such as the default condition is that if the first timer expires the priority class of the wireless backhaul link reverts to no-priority (e.g., a normal priority for an AP-to-AP link or a STA-to-AP link). Or alternatively the second AP 24 may explicitly signal the mobile first AP 22 with the new reduced priority.

Expiry of the second timer may be a true second timer or it may simply be some backoff factor from the first timer which runs for x milliseconds, in which x is predetermined. If the second timer expires and there is continuous inactivity on the wireless backhaul link, the mobile second AP 22 may in this embodiment release the wireless backhaul link (or at least its elevated priority) by sending to the second AP 24 a priority request release message 218. The mobile first AP 22 sends this message 218 when it has no more need for the backhaul connection and wishes to release its priority grant. In one embodiment noted above this release may occur upon expiry of the second timer (or expiry of some subset of the period of the first timer). In another embodiment this priority release may be initiated by the second AP 24 based on channel conditions, such as where the second AP 24 sees the signal quality of the mobile AP 22 falling below a certain level y or the signal level staying below the level y for the time period of k. The timers above may be implemented by a clock (oscillator) inherent within a processor of the respective access node 22, 24.

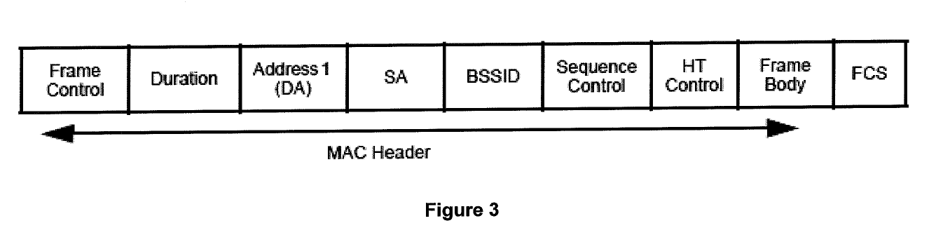

For the case in which the wireless backhaul link is according to the 802.11 WLAN radio access technology, FIG. 3 illustrates a format for a WLAN management frame. The priority request message 208 of FIG. 2 may be implemented as a public action frame, as an authentication frame, or as an association request in the body of a management frame. Public action frames conventionally enable unassociated inter BSS communication or unassociated STA to AP communications in WLAN. As adapted according to these teachings, the mobile first AP 22 can utilize the public action frames either via non-AP interface or AP to AP interface to indicate the priority request 208. Or in another embodiment the mobile first AP 22 can utilize authentication frame to convey the priority request 208 in the frame body of an authentication frame which is a particular type of management frame. For the case in which the mobile first AP 22 utilizes its non-AP interface to connect to the fixed AP, the priority indication 208 can be included in the association request message which is transmitted also in the frame body of a management frame. In these cases the priority indication 208 is a new information field within those conventional frame structures. FIG. 3 shows the frame body relative to other fields of the WLAN management frame.

In an alternative embodiment or complementation to the above management frame implementations, the priority request 208 from the mobile first access point 22 to the fixed second access point 24 triggers the switch of access modes from the distributed coordination function (DCF) to PCF/H(CF)CCA (point coordination function/Hybrid Coordination Function Controlled Channel Access) for the fixed BSS while the mobile first access point 22 is associated with the fixed second access point 24.

One technical effect of these teachings is that the priority indication from the mobile first AP 22 saves the link setup time and resource cost for the STAs associated to it since they don't have to re-associate to the fixed hot spot 24. And they facilitate fast setup of the wireless backhaul link since only one link has to be established between the mobile first AP 22 and the fixed second AP 24.

As noted above, the above WLAN specific examples are not limiting to the broader teachings herein, and the above techniques may be employed in other radio access technologies such as UTRAN and LTE to name only two others.

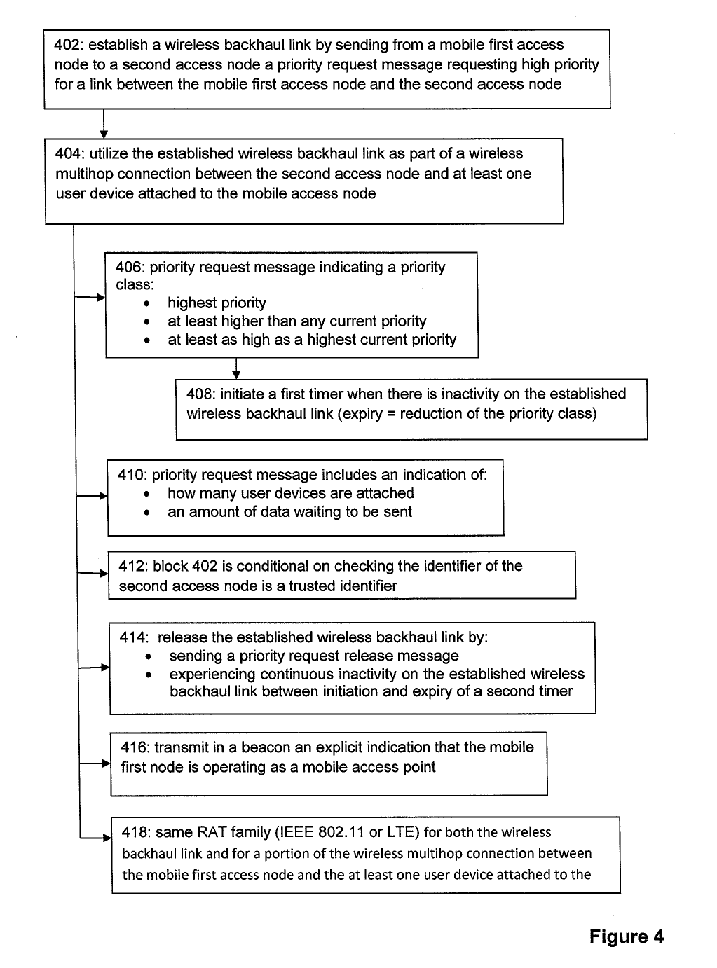

FIG. 4 details particular exemplary embodiments of the invention from the perspective of the mobile first access node 22 (or one or more components thereof). At block 402 of FIG. 4 a wireless backhaul link is established by sending from a mobile first access node 22 to a second access node 24 a priority request message 208 requesting high priority for a link between the mobile first access node and the second access node. Then at block 404 that established wireless backhaul link is utilized as part of a wireless multihop connection between the second access node 24 and at least one user device 20 attached to the mobile first access node 22. The multihop connection in FIG. 1 is two-hop but these teachings are not limited only to two-hop wireless connections nor to the second access node 24 being itself fixed.

Further portions of FIG. 4 are optional and may or may not be combined with one another in various embodiments. Block 406 gives the embodiment in which the priority request message 208 gives a priority class, which is selected from the group highest priority, at least higher than any current priority, and at least as high as a highest current priority. Block 408 describes that after the wireless backhaul link is established at block 402 then a first timer in initiated when there is inactivity on the established wireless backhaul link. Continuous inactivity on the established wireless backhaul link between the initiating and expiry of the first timer automatically results in a reduction of the priority class for the wireless backhaul link.

Block 410 gives various implementations of the priority request message 208. It may indicate how many user devices are attached to the mobile first access node, and/or it may indicate an amount of data waiting to be sent on the wireless backhaul link.

Block 412 relates to the check at block 206 of FIG. 2: sending of the priority request message 208 used to establish the wireless backhaul link is conditional on the mobile first access node 22 checking an identifier of the second access node 24 against a locally stored set of trusted identifiers.

Block 414 concerns releasing the wireless backhaul link which was established at block 402. It may be released by sending from the mobile first access node 22 to the second access node 24 a priority request release message 218, and/or by experiencing continuous inactivity on the established wireless backhaul link between initiation and expiry of a second timer 216A.

While the mobile first access node 22 has the wireless backhaul link established, it may periodically transmit a beacon 214 which includes an explicit indication that it is operating as a mobile access point as at block 416. And at block 418 the same RAT family such as for example IEEE 802.11 WLAN or 3GPP LTE/LTE-A is the radio access technology used for both the wireless backhaul link and for a portion of the wireless multihop connection between the mobile first access node 22 and the at least one user device 20 attached to the mobile first access node.

FIG. 4 is a logic flow diagram which may be considered to illustrate the operation of a method, and a result of execution of a computer program stored in a computer readable memory, and a specific manner in which components of an electronic device are configured to cause that electronic device to operate. The various blocks shown in FIG. 4 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

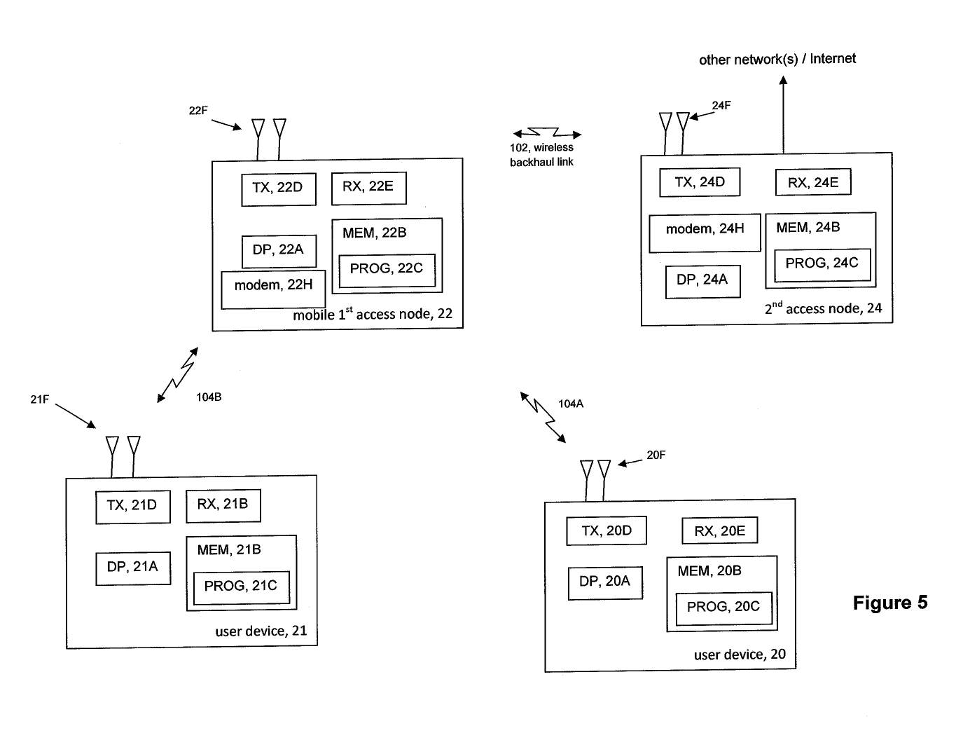

Reference is now made to FIG. 5 for illustrating a simplified block diagram of various electronic devices and apparatus that are suitable for use in practicing the exemplary embodiments of this invention. In FIG. 5 there is a mobile first access node 22 and a second access node 24 which are adapted for communication over wireless links 104A, 104B with two apparatus 20, 21, such as mobile terminals or UEs or STAs termed more generally as user devices. The second access node 24 may be further communicatively coupled to further networks (e.g., a publicly switched telephone network PSTN and/or a data communications network/Internet), possibly via a higher network node such as a serving gateway in the case of the LTE system.

The user device 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the node B 22 via one or more antennas 20F. The other user device is similarly functional with blocks 21A, 21B, 21C, 21D and 21F.

The mobile first access node 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with its associated user devices 20, 21 via one or more antennas 22F and a modem 22H. There is also a wireless backhaul link 102 established according to the above teachings between the mobile first access node 22 and the second access node 24.

Similarly, the second access node 24 includes processing means such as at least one data processor (DP) 24A, storing means such as at least one computer-readable memory (MEM) 24B storing at least one computer program (PROG) 24C, and communicating means such as a modem 24H and antennas 24F for bidirectional wireless communications with the mobile first access node 22 over the wireless backhaul link 102. While not particularly illustrated for the user devices 20, 21, those devices are also assumed to include as part of their wireless communicating means a modem which may be inbuilt on an RF front end chip within those devices 20, 21 and which also carries the TX 20D/21D and the RX 20E/21E.

At least one of the PROGs 22C, 24C in the mobile first access node 22 and in the second access node 24 is assumed to include program instructions that, when executed by the associated DP 22A, 24A, enable the device to operate in accordance with the exemplary embodiments of this invention as detailed more fully above. In this regard the exemplary embodiments of this invention may be implemented at least in part by computer software stored on the MEM 22B/24B which is executable by the DP 22A/24A of the respective first and second access nodes 22/24, or by hardware, or by a combination of tangibly stored software and hardware (and tangibly stored firmware). Electronic devices implementing these aspects of the invention need not be the entire access node 22/24, but exemplary embodiments may be implemented by one or more components of same such as the above described tangibly stored software, hardware, firmware and DP, or a system on a chip SOC or an application specific integrated circuit ASIC or a digital signal processor DSP or a modem or a subscriber identity module commonly referred to as a SIM card.

Various embodiments of the user device 20 can include, but are not limited to: cellular telephones; data cards, USB dongles, personal portable digital devices having wireless communication capabilities including but not limited to laptop/palmtop/tablet computers, digital cameras and music devices, and Internet appliances.

Various embodiments of the computer readable MEM 22B/24B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 22A/24A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the WLAN and LTE systems, it should be appreciated that the exemplary embodiments of this invention are not limited for use with only this one particular type of wireless communication system, and that they may be used to advantage in other wireless communication systems such as for example UTRAN, WCDMA and others.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method, comprising:
establishing a wireless backhaul link by sending from a mobile first access node to a second access node a priority request message requesting high priority for a link between the mobile first access node and the second access node; and
utilizing the established wireless backhaul link as part of a wireless multihop connection between the second access node and at least one user device attached to the mobile first access node.

2. The method according to claim 1, in which the priority request message requests the high priority by indicating a priority class selected from the group: highest priority, at least higher than any current priority, and at least as high as a highest current priority.

3. The method according to claim 2, the method further comprising, after the wireless backhaul link is established, initiating a first timer when there is inactivity on the established wireless backhaul link, in which continuous inactivity on the established wireless backhaul link between the initiating and expiry of the first timer automatically results in a reduction of the priority class for the wireless backhaul link.

4. The method according to claim 1, in which the priority request message further comprises an indication of how many user devices are attached to the mobile first access node.

5. The method according to claim 1, in which the priority request message further comprises an indication of an amount of data waiting to be sent on the wireless backhaul link.

6. The method according to claim 1, in which the priority request message is used to establish the wireless backhaul link conditional on the mobile first access node checking an identifier of the second access node against a locally stored set of trusted identifiers.

7. The method according to claim 1, the method further comprising releasing the established wireless backhaul link by one of:
sending from the mobile first access node to the second access node a priority request release message; and
experiencing continuous inactivity on the established wireless backhaul link between initiation and expiry of a second timer.

8. The method according to claim 1, the method further comprising the mobile first access node transmitting in a beacon an explicit indication that it is operating as a mobile access point.

9. The method according to claim 1, in which a same radio access technology family is used for both the wireless backhaul link and for a portion of the wireless multihop connection between the mobile first access node and the at least one user device attached to the mobile first access node.

10. An apparatus, comprising:
a processing system comprising at least one processor and a memory storing a set of computer instructions,
in which the processing system is arranged to:
establish a wireless backhaul link by sending from a mobile first access node to a second access node a priority request message requesting high priority for a link between the mobile first access node and the second access node; and
utilize the established wireless backhaul link as part of a wireless multihop connection between the second access node and at least one user device attached to the mobile first access node.

11. The apparatus according to claim 10, in which the priority request message requests the high priority by indicating a priority class selected from the group: highest priority, at least higher than any current priority, and at least as high as a highest current priority.

12. The apparatus according to claim 11, in which the processing system is further arranged to, after the wireless backhaul link is established, initiate a first timer when there is inactivity on the established wireless backhaul link, in which continuous inactivity on the established wireless backhaul link between the initiating and expiry of the first timer automatically results in a reduction of the priority class for the wireless backhaul link.

13. The apparatus according to claim 10, in which the priority request message further comprises an indication of at least one of:
how many user devices are attached to the mobile first access node; and
an amount of data waiting to be sent on the wireless backhaul link.

14. The apparatus according to claim 10, in which the priority request message is used to establish the wireless backhaul link conditional on the apparatus checking an identifier of the second access node against a set of trusted identifiers stored in a memory of the mobile first access node.

15. The apparatus according to claim 10, in which the processing system is further arranged to release the established wireless backhaul link by one of:
sending to the second access node a priority request release message; and
experiencing continuous inactivity on the established wireless backhaul link between initiation and expiry of a second timer.

16. The apparatus according to claim 10, in which the processing system is further arranged to transmit from the mobile first access node in a beacon an explicit indication that the mobile first access node is operating as a mobile access point.

17. The apparatus according to claim 10, in which a same radio access technology family is used for both the wireless backhaul link and for a portion of the wireless multihop connection between the mobile first access node and the at least one user device attached to the mobile first access node.

18. A computer readable memory storing a set of instructions which, when executed by an apparatus, cause the apparatus to:
establish a wireless backhaul link by sending from a mobile first access node to a second access node a priority request message requesting high priority for a link between the mobile first access node and the second access node; and
utilize the established wireless backhaul link as part of a wireless multihop connection between the second access node and at least one user device attached to the mobile first access node.

19. The computer readable memory according to claim 18, in which the priority request message requests the high priority by indicating a priority class selected from the group: highest priority, at least higher than any current priority, and at least as high as a highest current priority.

20. The computer readable memory according to claim 18, in which the priority request message further comprises an indication of at least one of:
how many user devices are attached to the mobile first access node; and
an amount of data waiting to be sent on the wireless backhaul link;
and the priority request message is used to establish the wireless backhaul link conditional on the mobile first access node checking an identifier of the second access node against a locally stored set of trusted identifiers.
